(19) United States
(12) Patent Application Publication
(10) Pub. No.: US 2005/0146206 A1
(43) Pub. Date: Jul. 7, 2005

(54) Staked spindle nut system

(76) Inventors: Jeff Moreau, Lawton, MI (US); Tom Lyon, Lawton, MI (US); Enrico Miracoli, Kalamazoo, MI (US); Dave Moses, Kalamazoo, MI (US)

Correspondence Address: DYKEMA GOSSETT PLLC, Suite 300, 39577 Woodward Avenue, Bloomfield Hills, MI, 48304, US

(21) Appl. No.: 10/744,784

(22) Filed: Dec. 22, 2003

(51) Int. Cl. B60B 35/00

(52) U.S. Cl. 301/124.1

(57) ABSTRACT

A wheel end assembly is provided that incorporates a staked spindle nut while minimizing potential thread damage on the nut and axle spindle. The assembly includes an axle spindle configured to support a wheel bearing. The axle spindle includes an inboard portion defining a plurality of threads and an outboard portion having a recess formed therein. The assembly further includes a nut having an inboard portion defining a plurality of threads configured to engage the threads on the axle spindle and an outboard portion in the form of a deformable collar. The nut is threaded onto the axle spindle and a portion of the collar is deformed to fit within the recess in the outboard portion of the axle spindle.

### BACKGROUND OF THE INVENTION

1. Field of the Invention

This invention relates to wheel end assemblies and, in particular, to a staked spindle nut system for retaining bearings on an axle spindle.

2. Discussion of Related Art

A conventional wheel end assembly includes a nut that is disposed over the outboard end of the axle spindle to retain the wheel bearings on the axle spindle. In many conventional wheel end assemblies, the nut is staked to the axle spindle by using a tool to deform a portion of the nut into a groove or recess in the axle spindle. Staking the nut helps to prevent rotation of the nut after assembly.

Conventional wheel end assemblies incorporating a staked spindle nut have a significant drawback. The groove or recess in the axle spindle into which the nut is staked is typically formed in the threads of the spindle. Further, the nut is deformed in such a way that the deformed portion of the nut is staked into the threads of the nut as well as the groove in the axle spindle threads. As a result, the threads on the axle spindle and nut are frequently damaged and further damage often occurs during servicing of the wheel end assembly.

The inventors herein have recognized a need for a wheel end assembly that will minimize and/or eliminate one or more of the above-identified deficiencies.

### SUMMARY OF THE INVENTION

The present invention provides a wheel end assembly.

A wheel end assembly in accordance with the present invention includes an axle spindle disposed about a central axis and configured to support a wheel bearing. The axle spindle has a first portion that defines a first plurality of threads and a second portion outboard of the first portion that defines a recess. The assembly further includes a nut having a first portion that defines a second plurality of threads configured to mate with the first plurality of threads of the axle spindle. The nut further has a second portion located outboard of the first portion. The second portion is deformable so as to be received within the recess in the axle spindle.

A wheel end assembly in accordance with the present invention is advantageous. The recess in the axle spindle and the deformable portion of the staking nut are located outboard of the threads on the axle spindle and nut. As a result, the process of staking the nut on the axle spindle does not interfere with, nor cause damage to, the threads on the axle spindle and nut. Further, the wheel end assembly can be serviced without damage to the threads of the axle spindle and nut.

These and other advantages of this invention will become apparent to one skilled in the art from the following detailed description and the accompanying drawings illustrating features of this invention by way of example.

### BRIEF DESCRIPTION OF THE DRAWINGS

FIGS. 1 is an exploded perspective view of a wheel end assembly in accordance with the present invention.

FIG. 2 is a cross-sectional view of the axle spindle of the wheel end assembly of FIG. 1.

### DETAILED DESCRIPTION OF EMBODIMENTS OF THE INVENTION

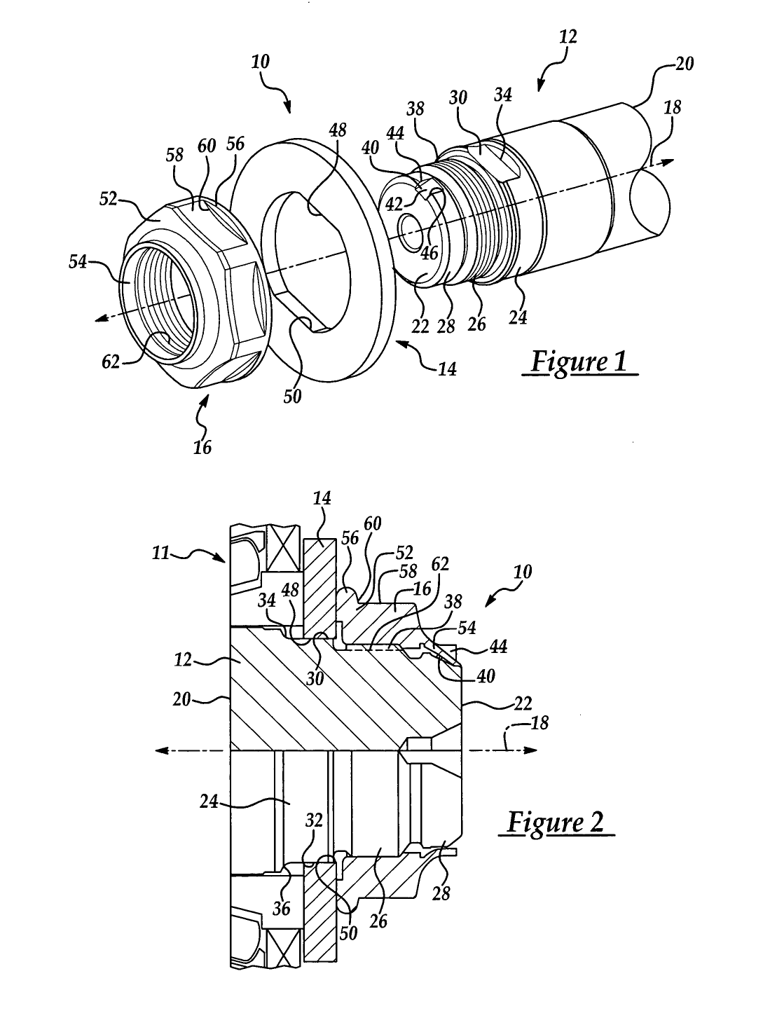

Referring now to the drawings wherein like reference numerals are used to identify identical components in the various views, FIGS. 1-2 illustrate a wheel end assembly 10 in accordance with the present invention. Assembly 10 is provided to support and retain a wheel (not shown) and wheel bearings 11 (one set of which is partially shown in FIG. 2) supporting the wheel. Assembly 10 is configured for use in supporting a vehicle wheel. It should be understood, however, that the inventive assembly could find use in a variety of applications in which an axle spindle or stub is used to support a wheel or other rotating member. Assembly 10 may include an axle spindle 12, a washer 14, and a nut 16.

Spindle 12 is disposed proximate one end of an axle (not shown) about a central axis 18 and is provided to support wheel bearings 11 and a wheel in a conventional manner. The wheel bearings 11 may comprise, for example, tapered inner and outer roller bearings. Spindle 12 may be used on a steer axle and may extend from a steering knuckle (not shown) in a conventional manner. Spindle 12 may be tubular or solid. Spindle 12 is generally circular in shape, but the diameter of spindle 12 may vary along axis 18. In the illustrated embodiment, the variation in diameter results in a stepped change in diameter moving from an inboard end 20 of spindle 12 to an outboard end 22 of spindle 12. It should be understood, however, that the size and shape of spindle 12 may be altered in certain respects without departing from the spirit of the present invention. For example, the diameter of spindle 12 may change through a gradual tapering over certain axial sections of spindle 12.

Spindle 12 includes several portions 24, 26, 28. Portion 24 is substantially circular, but defines at least one flat 30—and preferably two diametrically opposed flats 30, 32 for a purposed described below. Flats 30, 32 are formed at an outboard end of portion 24 such that the inboard edge of each flat 30, 32 terminates at a shoulder 34, 36. Portion 26 is disposed outboard of portion 24 and inboard of portion 28. Portion 26 defines a plurality of threads 38 for a purpose described below. At least some, and preferably all, of threads 38 are unbroken. In the present context the term “unbroken” means that a particular thread extends around an entire circumference of spindle 12 without interruption. In particular, there is no groove or recess cut in the threads 38 to allow for staking of the nut 16. Portion 28 is located outboard of portions 24 and 26. The diameter of portion 26 may be greater than the diameter of portion 28 with the diameter of portion 28 smaller than the minor diameter of threads 38 on portion 26. Portion 28 includes a recess 40 which is defined by bottom wall 42 and side walls 44, 46 in the illustrated embodiment. Bottom wall 42 is substantially rectangular in shape while side walls 44, 46 are substantially triangular in shape. In the illustrated embodiment the depth of recess 40 increases moving from an inboard end of recess 40 to an outboard end of recess 40 so to facilitate staking of nut 16 as described below. It should be understood that recess 40 could be configured in different ways. For example, the depth of recess 40 may remain constant moving from an inboard end to an outboard end of recess 40 to define a conventional key slot.

Washer 14 is provided to help retain nut 26 and to absorb thrust forces in a conventional manner. Washer 14 may be generally circular in shape and is disposed on an inboard side of nut 16. The inner diameter of washer 14 defines at least one, and preferably two diametrically opposed flats 48, 50 configured to engage corresponding flats 30, 32 on axle spindle 12. Washer 14 is slid over spindle 12 with flats 48, 50 and 30, 32 aligned and is restrained from further movement inboard by one of bearings 11 or shoulders 34, 36 in portion 24 of spindle 12.

Nut 16 is provided to retain the wheel bearings on axle spindle 12. Nut includes several portions 52, 54. Portion 52 is further inboard of portion 54 upon assembly of assembly 10. An inboard end of portion 52 defines a substantially circular flange 56. The remainder of portion 52 defines a plurality of flats 58 configured for engagement by a suitable tool used to rotate nut 16. The intersection of flange 56 with each flat 58 defines a shoulder 60. Portion 52 further defines a plurality of threads 62 on a radially inner surface. At least some, and preferably all, of threads 62 are unbroken. In the present context the term “unbroken” means that a particular thread extends around an entire inner circumference of nut 16 without interruption. Portion 54 is located outboard of portion 52. In the illustrated embodiment, portion 54 comprises a circular collar extending outboard from portion 52. Portion 54 is deformable and is configured to be received within recess 40 in portion 28 of spindle 12. The inner diameter of portion 54 is smaller than the minor diameter of threads 62 in portion 52 and is sized relative to the diameter of portion 28 of spindle 12.

A wheel end assembly 10 in accordance with the present invention is advantageous as compared to conventional wheel end assemblies. The location of the recess 40 in spindle 12 and the deformable portion 54 of nut 16 outboard of threads 38 on spindle 12 and threads 62 on nut 16 enables staking of nut 16 without interference with, or damage to, any of threads 38, 62. Nut 16 is threaded onto spindle 12 and an appropriate tool is used to deform portion 54 of nut 16 by bending at least a segment of portion 54 radially inward into recess 38. Removal of nut 16 is effected by returning portion 54 to its original shape and, therefore, servicing of assembly 10 also will not result in any damage to threads 38, 62.

While the invention has been shown and described with reference to one or more particular embodiments thereof, it will be understood by those of skill in the art that various changes and modifications can be made without departing from the spirit and scope of the invention. For example, in the illustrated embodiment only a single recess 40 is shown. It should be understood that multiple recesses 40 could be located circumferentially around spindle 12 and portion 52 of nut 16 could be deformed in multiple locations to increase resistance to rotation.

1. A wheel end assembly, comprising:
an axle spindle disposed about a central axis and configured to support a wheel bearing, said axle spindle having a first portion defining a first plurality of threads and a second portion outboard of said first portion defining a recess; and,
a nut having a first portion defining a second plurality of threads configured to mate with said first plurality of threads and a second portion located outboard of said first portion of said nut, said second portion deformable so as to be received within said recess in said axle spindle.

2. The wheel end assembly of claim 1 wherein a diameter of said first portion of said axle spindle is greater than a diameter of said second portion of said axle spindle.

3. The wheel end assembly of claim 1 wherein each thread of said first plurality of threads is unbroken.

4. The wheel end assembly of claim 1 wherein a depth of said recess increases moving from an inboard end of said recess to an outboard end of said recess.

5. The wheel end assembly of claim 1 wherein said second portion of said nut comprises an annular collar extending from said first portion of said nut.

6. The wheel end assembly of claim 1 wherein each thread of said second plurality of threads is unbroken.

7. A wheel end assembly, comprising:
an axle spindle disposed about a central axis and configured to support a wheel bearing, said axle spindle having a first portion defining a first plurality of threads and a second portion outboard of said first portion defining a recess;
a nut having a first portion defining a second plurality of threads configured to mate with said first plurality of threads and a second portion located outboard of said first portion of said nut, said second portion deformable so as to be received within said recess in said axle spindle; and,
a washer disposed on an inboard side of said first nut.

8. The wheel end assembly of claim 7 wherein said washer includes a first flat configured to engage a corresponding flat on said axle spindle.

9. The wheel end assembly of claim 8 wherein said washer includes a second flat diametrically opposite said first flat.

10. The wheel end assembly of claim 8 wherein said corresponding flat of said axle spindle is disposed inboard of said first portion of said axle spindle.

12. The wheel end assembly of claim 8 wherein said corresponding flat is aligned with said recess in said second portion of said axle spindle.

13. The wheel end assembly of claim 7 wherein a diameter of said first portion of said axle spindle is greater than a diameter of said second portion of said axle spindle.

14. The wheel end assembly of claim 7 wherein each thread of said first plurality of threads is unbroken.

15. The wheel end assembly of claim 7 wherein a depth of said recess increases moving from an inboard end of said recess to an outboard end of said recess.

16. The wheel end assembly of claim 7 wherein said second portion of said nut comprises an annular collar extending from said first portion of said nut.

18. The wheel end assembly of claim 7 wherein each thread of said second plurality of threads is unbroken.

19. A wheel end assembly, comprising:
an axle spindle disposed about a central axis and configured to support a wheel bearing, said axle spindle having a first portion defining a first plurality of unbroken threads and a second portion outboard of said first portion defining a recess, a depth of said recess increasing moving from an inboard end of said recess to an outboard end of said recess; and,
a nut having a first portion defining a second plurality of unbroken threads configured to mate with said first plurality of unbroken threads and a second portion comprising an annular collar located outboard of said first portion, said second portion deformable so as to be received within said recess in said axle spindle.

20. The wheel end assembly of claim 19, further comprising a washer disposed on an inboard side of said nut, said washer including a pair of diametrically opposed flats configured to engage corresponding flats on said axle spindle disposed inboard of said first portion of said axle spindle and aligned with said recess in said second portion of said axle spindle.
